(19) United States
(12) Patent Application Publication
(10) Pub. No.: US 2009/0194382 A1
(43) Pub. Date: Aug. 6, 2009

(54) CLUTCH

(76) Inventor: Helmut Ristl, Schwieberdingen (DE)

Correspondence Address: CONNOLLY BOVE LODGE & HUTZ LLP, 1875 EYE STREET, N.W., SUITE 1100, WASHINGTON, DC, 20006, US

(21) Appl. No.: 12/092,441

(22) PCT Filed: Nov. 3, 2006
(86) PCT No.: PCT/EP2006/010567

§ 371 Date: Oct. 2, 2008

(30) Foreign Application Priority Data
Nov. 4, 2005 (DE) 10 2005 053 154.7

(51) Int. Cl. F16D 31/02

(52) U.S. Cl. 192/60

(57) ABSTRACT

The invention relates to a clutch for connecting a component at the driving end and a component at the driven end. Said clutch comprises at least one first and a second clutch part (2, 55; 1, 53). The aim of the invention is to create a clutch which can be switched during operation, operates essentially without dissipating power, and is wear-free and thus maintenance-free. Said aim is achieved by at least one hollow chamber in the first clutch part (2, 55), said hollow chamber being open on at least one side, forming at least one fluid chamber (12, 63), and being closed by a wall on the second clutch part (1, 53), the hollow chamber and the wall being movable relative to each other, as well as at least one slide (17) which is mounted on the second clutch part (1, 53) in the area of the wall and by means of which the fluid chamber (12, 63) can be subdivided at least in part perpendicular to the direction of the relative movement.

### PRIOR ART

The invention concerns a clutch for connecting a component on the drive side and a component on the driven side, with at least a first and a second clutch part.

In clutches, we distinguish in principle between form-fit clutches and force-fit clutches.

In form-fit clutches, two shafts are coupled together via for example bolts, claws or teeth. These clutches have the disadvantage that they can only be switched when the shafts are stopped, rotating at the same speed or at low relative speeds. They can only work when the shafts to be connected are in discrete positions.

Force-fit clutches are above all friction clutches. Here the force flow is created by pressing together friction surfaces which are each connected, rotationally stationary but displaceably, with a shaft.

These clutches can be switched during operation. In the single plate dry clutch most often used in automotive engineering, the force engagement and torque transfer or speed adaptation take place such that an axially displaceable clutch plate, connected rotationally stationary with the gearbox shaft, is pressed under spring pressure with varying force against the engine flywheel and carried by this due to friction with or without corresponding slippage. To release the clutch, the clutch plate is separated from the flywheel. If very high torques are to be transferred or the clutch can only have small dimensions, two-plate or multi-plate clutches (multi-disc clutches) are used. An essential disadvantage of friction clutches is that they are subject to comparatively high wear due to abrasion on the friction surfaces and the thermal load imposed by the friction. In addition, friction clutches cannot work without power dissipation.

The clutches can be switched externally by mechanical, electrical, hydraulic or pneumatic external intervention. However automatically operating clutches are known, such as centrifugal clutches or slip clutches, which only switch after reaching a specific rotation speed or torque.

### 2. Solution According to the Invention

The object of the present invention is to create a new type of clutch which can be switched during operation, works substantially without power dissipation, is free from wear and hence maintenance-free.

This object is achieved by a clutch of the type cited initially with the features of the main claim. The sub-claims contain advantageous embodiments.

The basic concept of the present invention lies in that, through at least one slide which engages in a fluid chamber to switch the clutch while the clutch parts are moving relative to each other, a pressure is exerted on the fluid in the fluid chamber so that the first clutch part is carried due to the pressure exerted on the wall of the fluid chamber.

To be able to build up the pressure within the fluid chamber in the direction of the movement of the second clutch part relative to the first clutch part, the slide is formed preferably so that it can at least partly divide the fluid chamber transverse to the direction of relative movement. The further the slide engages in the fluid chamber during a switching process, the less fluid can flow past the slide inside the fluid chamber so that the slip between the two clutch parts becomes less, the further the slide protrudes into the fluid chamber until the slip becomes zero when the fluid chamber is completely divided by the slide. The advance speed of the slide in the fluid chamber within certain limits can be used to determine whether the clutch switches “hard” or “soft”.

To guarantee that the force transmission from the second clutch part to the first clutch part takes place with as little slip as possible, it is sensible if the wall of the second chamber seals the cavity or fluid chamber as tightly as possible, to prevent escape of the fluid from the fluid chamber during engagement of the slide in the fluid chamber. Where a certain degree of slip between the second clutch part and the first clutch part can be accepted, tight sealing of the fluid chamber by the wall is not essential.

As the force is transmitted from the second clutch part to the first clutch part via a fluid, the clutch according to the invention offers the advantages of both form-fit and force-fit clutches, without however having the disadvantages of such previously known clutches. So, the clutch according to the invention works essentially without friction and hence wear and is therefore maintenance-free. Also, substantially slip-free force transmission is possible, and switching can take place at a high relative speed between the first and second clutch parts. Switching is substantially free from power dissipation, whereby thermal load on the clutch during switching is effectively avoided.

In a preferred embodiment of the clutch according to the invention, the cavity side opposite the wall of the second clutch part in the direction of relative movement is formed undulating or hyperbolic involute-like, so that in the cavity there are at least two fluid chambers. By use of a multiplicity of fluid chambers, it is possible for better load distribution to use several slides for force transmission from the second clutch part to the first clutch part. A further advantage is that, with existing slip between the second clutch part and the first clutch part, a slide can move from a first to a second, adjacent fluid chamber without remaining “hanging” on an edge in the region of the transition from one fluid chamber to an adjacent fluid chamber.

In principle, the clutch according to the invention can be used for a multiplicity of applications, such as for example the transmission of forces between parallel endless belts. The invention is particularly suitable however for the transmission of forces between clutch parts, both of which are rotatably mounted.

A preferred embodiment of the clutch according to the invention has a clutch inner part and a clutch outer part, which connect two components mounted concentrically about a rotation axis. The components can for example be a shaft and a wheel sitting thereon, for example a gear cog of a gearbox. This allows the possibility of structuring a manual gearbox extremely compactly, since to fix a gearwheel switchably on a shaft, usually axially acting displacement mechanisms are used for form-fit clutches or multi-plate clutches which require substantially more space than the clutch according to the invention.

The inner clutch part can for example be formed as a disc with an outer surface concentric to the disc rotation axis as a wall which closes one or more fluid chambers provided in an inner hollow casing formed by the clutch outer part.

The clutch according to the invention is also suitable for connecting two mutually aligned shafts. For this the first clutch part can be formed at one end of one of the two shafts with a cavity that is open in the direction towards the other shaft and is closed by a wall formed at the other end of the two shafts which extends transverse to their axis of rotation.

Depending on the nature of the fluid used or the fill quantity of the fluid in the fluid chamber, in particular when the fluid chamber is totally filled with the fluid, it may be necessary for the fluid which is displaced by the slide entering the fluid chamber to be discharged in order to allow the slide to enter the fluid chamber. For this, in the slide at least one fluid channel can be formed which on movement of the slide into the fluid chamber allows passage of the displaced fluid into a compensation chamber which becomes exposed in the second clutch part behind the slide in the slide movement direction.

Alternatively or additionally, the fluid chamber can be connected via corresponding channels in the second clutch part with a fluid supply unit with which the static pressure within the fluid chamber can be adjusted; this pressure is superposed over the pressure generated by the slide, wherein on entry of the slide into the fluid chamber the displaced fluid is received by the fluid supply unit and on movement of the slide out of the fluid chamber, fluid can be returned to the fluid chamber by the fluid supply unit.

The response characteristics of the clutch can be influenced via the design of the face edge of the slide facing the fluid chamber, in particular the design of the contour of the slide in the direction of the relative movement. The contour can for example be rectangular, triangular, oblique, concave or convex. Depending on the contour of the slide, during the remaining relative movement between the first and the second clutch parts, another flow of fluid forms at the slide with the desired consequence of different clutch characteristics.

The slide can preferably be firmly connected with a piston which is mounted in the second clutch part. Such a piston can be activated for example hydraulically, electromagnetically or pneumatically in a guide provided for this in the second clutch part.

The slide can also be moved against a spring force, where with sufficient slide mass it is possible to design the clutch according to the invention as a centrifugal clutch.

In particular with the design of the clutch according to the invention with rotatably mounted clutch parts, it can be useful if the number of slides is greater than the number of fluid chambers, in particular if the fluid chambers and the slides are each evenly distributed in the peripheral direction of the respective clutch parts. In this way it can be ensured that independently of the relative position of the clutch parts, one slide always projects into one of the fluid chambers.

Suitable fluids are in particular incompressible fluids, visco-elastic fluids which are reversibly compressible to a specific degree, and gels.

In particular when the clutch according to the invention is used as a start-up clutch, it can be useful to provide mechanical means for connecting the clutch parts together by form fit as soon as, alter switching the clutch, the relative movement between the second and the first clutch parts has reduced to a minimum or no further slip exists.

The invention is now described in more detail below with reference to the enclosed drawings which show several preferred embodiment examples of the clutch according to the invention and parts thereof. The drawings show:

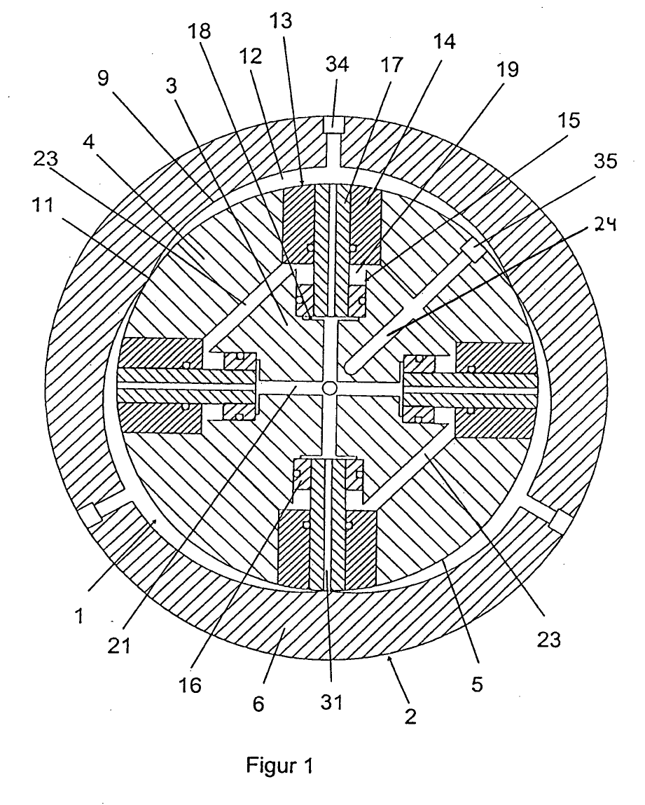

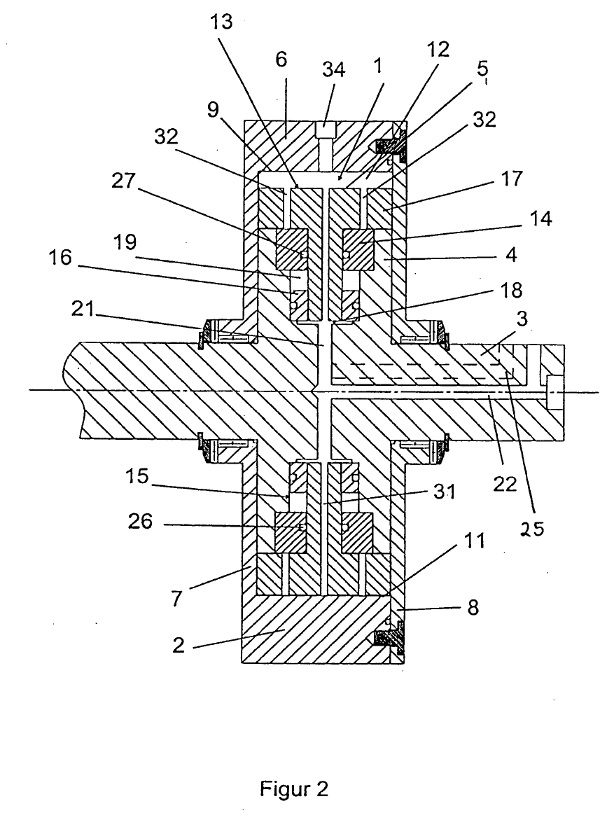

FIG. 1 a first embodiment of the clutch cut transverse to its axis of rotation, in unswitched state;

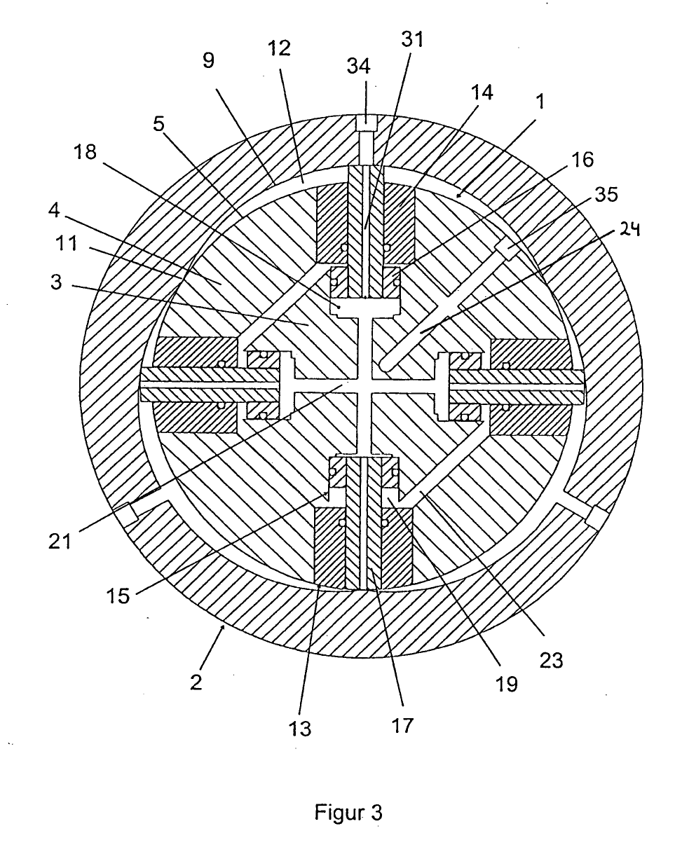

FIG. 2 the first embodiment cut along the axis of rotation, in unswitched state;

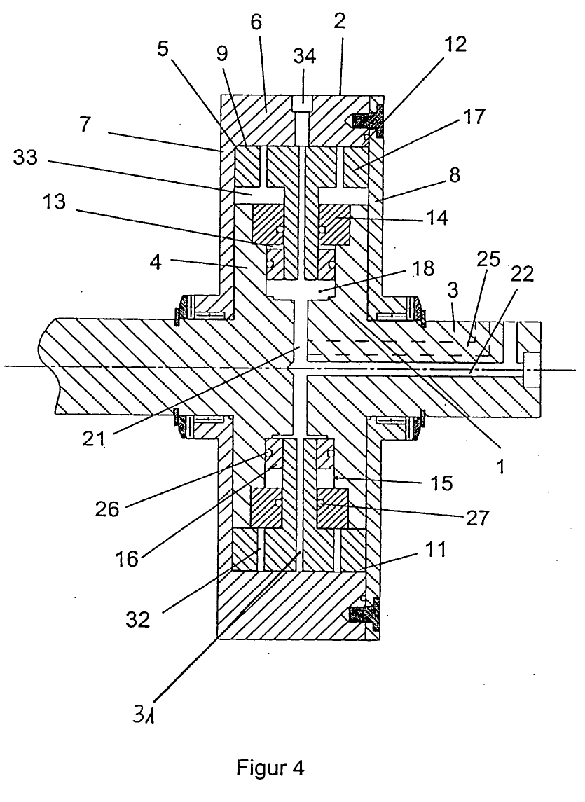

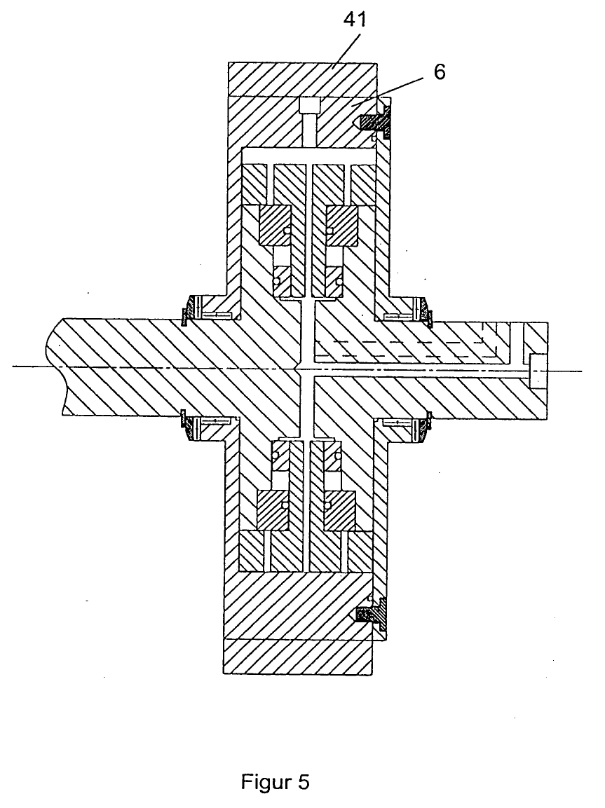

FIG. 3 the first embodiment cut transverse to the axis of rotation, in switched state;

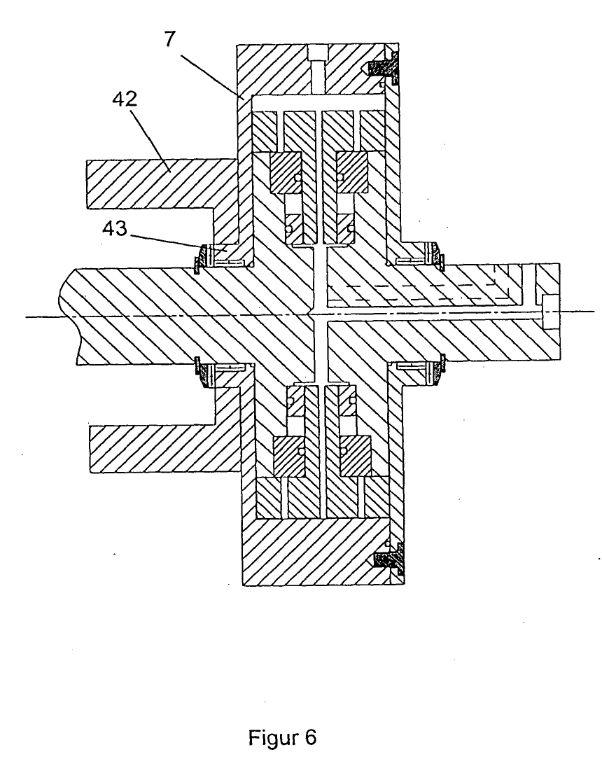

FIG. 4 the first embodiment cut along the axis of rotation, in switched state;

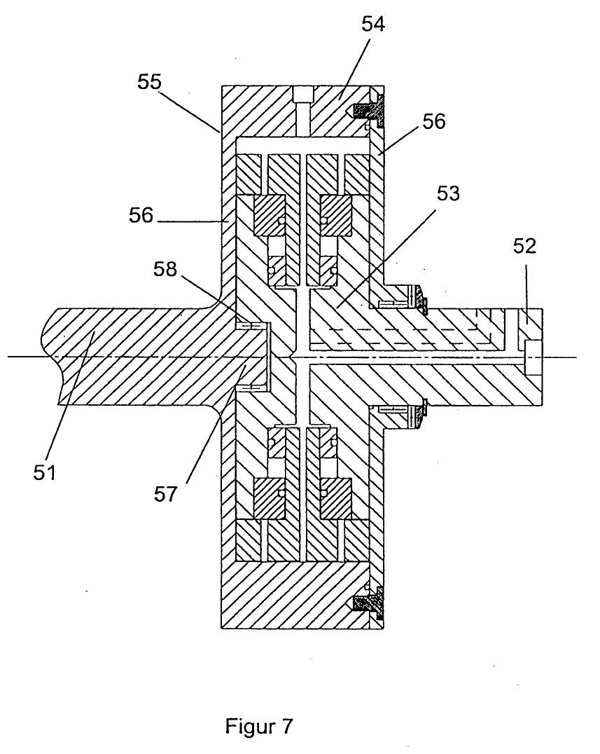

FIG. 5 a second embodiment cut along its axis of rotation, in unswitched state;

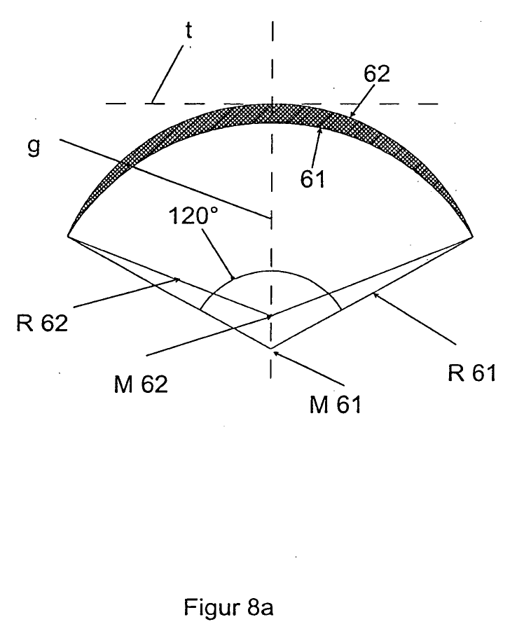

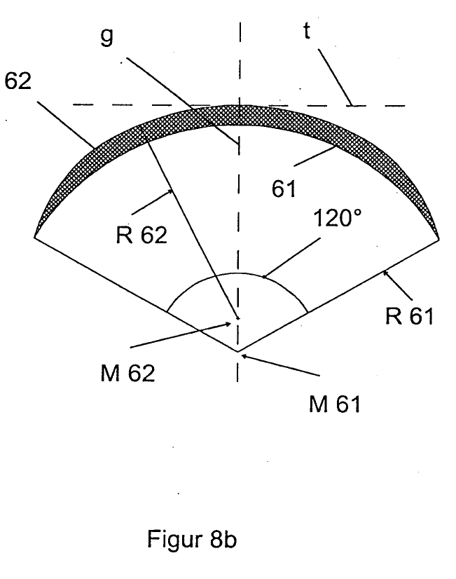

FIG. 6 a third embodiment cut along its axis of rotation, in switched state;

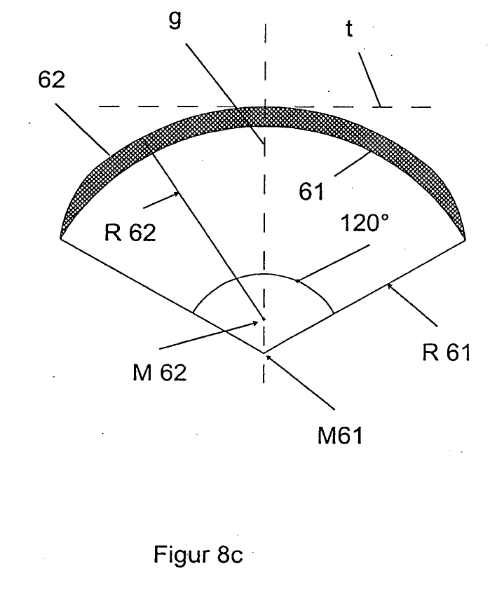

FIG. 7 a fourth embodiment cut along its axis of rotation, in unswitched state;

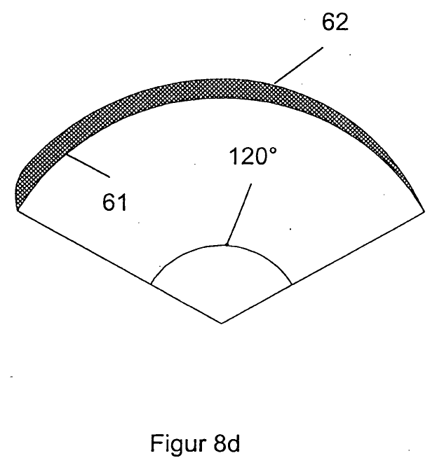

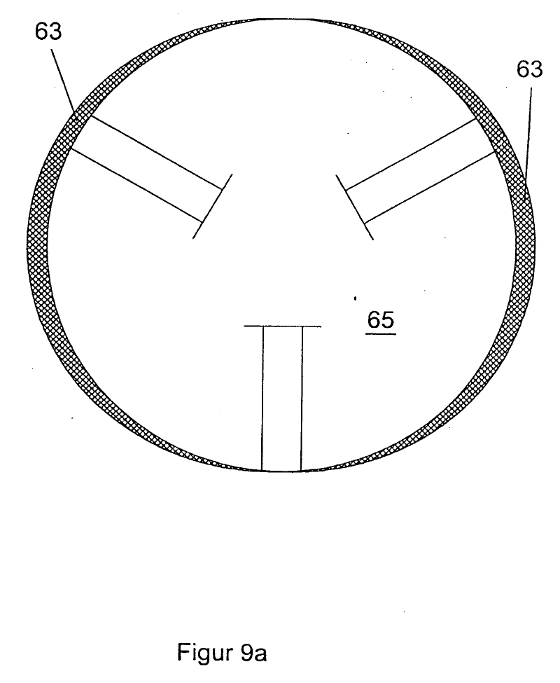

FIGS. 8a to 8d various forms of fluid chambers cut transverse to the axis of rotation of the clutch;

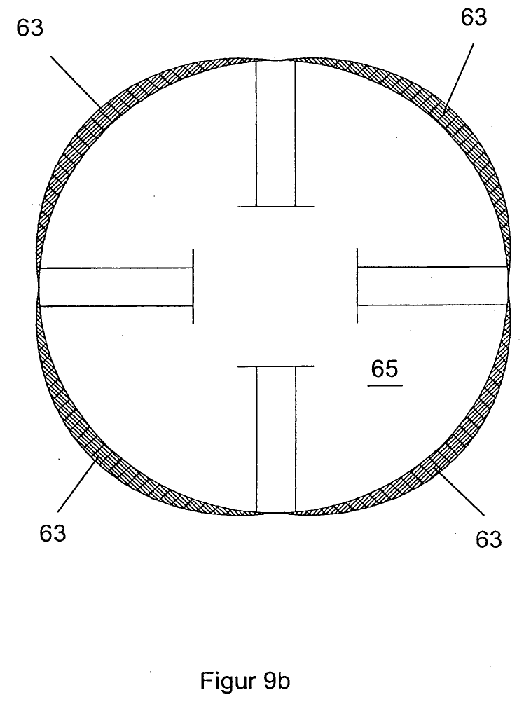

FIGS. 9a, 9b diagrammatic depictions of different relative arrangements of fluid chambers and slide devices; and

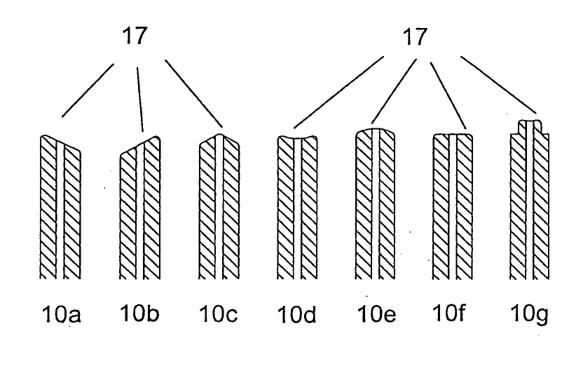

FIGS. 10a to 10g cross-sections of various embodiments of a slide.

In the description below, the same reference numerals are used for equivalent components.

The embodiment shown in FIGS. 1 to 4 of the clutch according to the invention has a clutch inner part 1 and surrounding this a clutch outer part 2. The clutch inner part 1 has a disc ring 4 formed on a shaft 3, the casing surface 5 of which runs concentric to the longitudinal axis of the shaft 3.

The clutch inner part 1 is completely surrounded by the clutch outer part 2. The clutch outer part 2 comprises a hollow cylindrical casing body 6 completely surrounding the disc ring 4 of the clutch inner part 1, which casing body is held by wall discs 7, 8 mounted rotatably in front and behind the clutch inner part 1 viewed in the shaft longitudinal direction. The wall disc 7 is permanently connected with the casing body 6, while the wall disc 8 is screwed to the casing body 6. The width of the casing body 6 corresponds to the width of the disc ring 4.

As can be seen in particular in FIGS. 1 and 3, the inner casing surface 9 of the casing body 8 does not run parallel to the outer casing surface 5 of the ring disc 4 but is formed undulating or hyperbolic involute-like, wherein the inner radius of the inner casing surface 9 reaches a minimum at part circle sections each offset by 120°. At these points 11, the radius of the inner casing surface 9 corresponds to the radius of the outer casing surface 5. As a result, between the clutch inner part 1 and the clutch outer part 2 are formed three fluid chambers 12. The regions in which the radius of the inner casing surface 9 corresponds to the radius of the outer casing surface 5 can also be made wider than shown. The displacement of the fluid from one fluid chamber to an adjacent fluid chamber becomes more difficult as a result.

In disc ring 4 of the clutch inner part 1, recesses 13 extending radially inward from the outer casing surface are provided, each for one slide guide 14 and one piston guide 15 aligning with the slide guide 14 and lying radially further in. The recesses 13 are arranged offset to each other by 90° in the peripheral direction. The slide guide 14 is pressed into the recess 13 from the outside.

In each piston guide 15 sits a piston 16, in each of which is inserted (screwed) a slide 17 extending radially outward. The pistons 16 and slides 17 are radially mobile in the piston guides 15 and slide guides 14. The movement of the pistons 16 is limited radially inwardly by a stop which is provided in front of the pressure chambers 18 lying radially inward. The movement of the pistons 16 is limited radially outwardly by the outer casing surface 9.

On the radially inner and radially outer faces of the pistons are provided pressure chambers 18, 19. The inner pressure chambers 18 are connected via radially running pressure lines 21 located in the region of the rotation axis of the shaft 3, which lines can be pressurised with a fluid via a supply line 22 running along the rotation axis of the shaft. The outer pressure chambers 19 are connected together via pressure lines 23 which extend between adjacent pressure chambers 19. One of the pressure lines 23 is connected via a radially inward running line 24 with a supply line 25 running parallel to supply line 22 in the shaft 3 so that also the radially outer pressure chambers 19 can be pressurized with a fluid.

The supply lines 22, 25 are each supplied by a fluid line directed radially towards the outside, wherein the shaft 3 at the outlet of each supply line is surrounded by a ring chamber not shown running fluid-tight around the shaft 3, each ring chamber being connected with a fluid supply unit also not shown.

The radially inner pressure chambers 18 are sealed against the radially outer pressure chambers 19 via piston sealing rings 26, so that when the radially inner pressure chambers 18 are pressurized by a fluid, the pistons 16 and slides 17 are moved radially outward, whereas they are moved radially inward again when the pressure chambers 19 are placed under pressure.

Within the slide guides 14 are also provided sealing rings 27 to seal the radially outer pressure chambers 19 against the fluid chambers 12.

If a slide 17 is pushed into a fluid chamber 12, the fluid in the fluid chamber is displaced. To allow movement of the slide, it must be discharged from the fluid chamber. For this, in the slides 17 are provided fluid channels 31 which extend radially within the slides 17 and connect the respective fluid chambers 12 with the radially inner pressure chambers 18.

As can be gathered in particular from FIGS. 2 and 4, the slides 17 extend over the entire width of the fluid chambers 12 so that they can divide the fluid chambers in the clutch outer part 2 fully or partly transverse to the direction of rotation of the clutch inner part 1. In each slide 17, to the right and left in the axial direction next to the fluid channel 31, are provided further fluid channels 32 through which fluid displaced from fluid chamber 12 by the slide 17 can flow into a compensation chamber 33 which becomes clear when the slide 17 is moved radially outward.

The fluid chambers 12 can be vented or evacuated via vent lines 34 passing radially through the casing body 6. The fluid chambers 19 are vented through the vent bore 34 via a valve 35.

FIGS. 1 to 4 show the fundamental principle of an embodiment example of a clutch according to the invention, wherein FIGS. 1 and 2 show the clutch in unswitched state in which the outer face edges of the slide 17 terminate flush with the outer casing surface 5 of the clutch inner part 1 and do not engage in the fluid chamber 12, and FIGS. 3 and 4 show the clutch in switched state in which the outer face edges of the slide 17 lie against the inner casing surface 5 of the clutch outer part 2 and divide the fluid chambers 12.

In FIG. 5, the clutch shown in FIGS. 1 to 4 is shown with a toothed ring 41 sitting on the casing body 6. In this case the clutch outer part forms the body of a gear wheel, for example a gear cog, which can be mounted rotatably on a shaft and firmly coupled thereto.

The embodiment example shown in FIG. 6 differs from the embodiment example shown in FIG. 5 in that a toothed ring 42 does not sit on the casing body 6, but on a ring flange 43 formed on the wall disc 7 and running concentric to the shaft, which serves simultaneously as a bearing housing for the bearing for the wall disc 7.

FIG. 7 shows a further preferred embodiment with two shafts 51, 52 connected via the clutch. The clutch inner part 53 is identical to the clutch inner part 1 shown in FIGS. 1 to 4. The casing body 54 of the clutch outer part is held on its side facing the shaft 51 via a wall disc 56 which is formed at the end of the shaft 51. On its side facing away from the shaft 51, the casing body 54 is held via a wall disc 56 screwed to it and mounted rotatably on the shaft 52. At the end of the shaft 51 is formed a cylindrical bearing seat 57 for a bearing 58 sitting in a corresponding recess in the end of the shaft 52.

FIGS. 8a to 8d show different forms of fluid chambers. The fluid chamber form shown hatched in FIG. 8a is formed by two part circle sections 61, 62 with different radii of curvature, wherein the radius of curvature of the inner part circle section 61 is given by the radius r₆₁ of the outer casing surface of the clutch inner part and encloses an angle of 120°. The outer radius of curvature r₆₂ is smaller than the inner radius of curvature r₆₁, wherein circle centre points M₆₁, M₆₂ of the part circle sections 61, 62 lie on a straight line g which runs perpendicular to a tangent t lying on the bisecting point of one of the two part circle sections 61, 62, i.e. in the region of the largest clear height of the fluid chamber.

The fluid chamber forms shown in FIGS. 8b and 8c differ from that in FIG. 8a in that the circle centre point M₆₂ for the outer part circle section 62 on straight line g is moved further out, wherein the part circle sections 62 in the edge zones run more steeply to the inner part circle section 61. The edge zone in FIG. 8b is slightly longer and runs at a flatter angle to the inner part circle section 61 than in FIG. 8c.

The fluid chamber form shown in FIG. 8d differs from the previous fluid chamber forms in that the spacing of the past circle sections 61, 62 enlarges constantly starting from one side and only runs together again in a short edge zone, on the left in the picture.

FIGS. 9a and 9b show two different arrangements of fluid chambers 63 for the clutch according to the invention, one with two fluid chambers which each extend over a part circle section of 180° (FIG. 9a), and one with four fluid chambers which each extend over part circle sections of 90° (FIG. 9b). In each of the clutch inner parts 65 shown, three slide guides 64 are provided which are each arranged offset by 120° to each other.

FIGS. 10a to 10g show slides 17 in cross-section with differently formed face edges on the fluid chamber side. The profile shown corresponds to the cross-section profile in the direction transverse to the axis of rotation when the slide is inserted in the clutch inner part. The slides shown in FIGS. 10a and 10b have chamfered face edges. The face edge profile shown in FIG. 10c is chamfered on both sides and towards the centre runs tapering radially outwardly. The face edge profile shown in FIG. 10d runs concave, the face edge profile shown in FIG. 10e convex. The face edge profile in FIG. 10f is substantially flat with rounded face edges, whereas the face edge profile shown in FIG. 10g is flat in the side edges and has a central protrusion directed radially outwards, the face of which is formed slightly concave. With the various face edge profiles, the response behaviour of the clutch can be influenced, in particular with regard to a “soft” or “hard” switching.

1. A clutch for connecting a component on the drive side and a component on the driven side, said clutch including at least a first and a second clutch part; at least one cavity, open to at least one side and forming at least one fluid chamber in the first clutch part, which is closed by a wall on the second clutch part, wherein the cavity and wall are movable relative to each other; at least one slide mounted on the second clutch part in the area of the wall, with which side the fluid chamber can be at least partly divided transverse to the direction of relative movement; and at least one fluid channel in said slide; and further including at least one radially inner pressure chamber and at least one radially outer pressure chamber provided in said second clutch part, which can be pressurized independently; and a piston connected with said slide, said piston being radially movable between said pressure chambers, said fluid channel connecting said fluid chamber with said radially inner pressure chamber and allowing the passage of displaced fluid from said fluid chamber into said radially inner pressure chamber.

2. The clutch according to claim 1, wherein the side of the cavity opposite the wall in the direction of the relative movement, is formed undulating or hyperbolic-involute shaped, such that in the cavity are formed at least two fluid chambers.

3. The clutch according to claim 1, wherein the two clutch parts are rotatably mounted.

4. The clutch according to claim 3, wherein a clutch inner part and a clutch outer part which connect two components mounted concentrically about a rotation axis.

5. The clutch according to claim 4, wherein the components are a shaft and a gear wheel sitting thereon.

6. The clutch according to claim 4, wherein the clutch inner part is formed disc-like with an outer surface, concentric to the rotation axis of the disc, as a wall which closes the one or more fluid chambers provided in a hollow casing formed by the clutch outer part.

7. The clutch according to claim 3, wherein the clutch parts connect two mutually aligned shafts.

8. The clutch according to claim 7, wherein the first clutch part is formed at one end of one of the two shafts with a cavity which is open in the direction towards the other shaft and is closed by a wall formed at the other end of the two shafts and extending transverse to its rotation axis.

9. The clutch according to claim 1, wherein at least another fluid channel in said slide, which on displacement of the slide into the fluid chamber allows the passage of displaced fluid into a compensation chamber in the second clutch part, which chamber becomes exposed behind the slide in the movement direction of the slide.

10. The clutch according to claim 1, wherein the channels in the second clutch part, via which the at least one fluid chamber is connected with a fluid supply unit with which a static pressure, superposed over a pressure generated in the fluid chamber by the slide, can be adjusted and/or controlled.

11. The clutch according to claim 1, wherein a slide with a face edge formed rectangular in the direction of relative movement.

12. The clutch according to claim 1, wherein a slide with a face edge formed triangular in the direction of relative movement.

13. The clutch according to claim 1, wherein a slide with a face edge formed oblique in the direction of relative movement.

14. The clutch according to claim 1, wherein a slide with a face edge formed concave in the direction of relative movement.

15. The clutch according to claim 1, wherein a slide with a face edge formed convex in the direction of relative movement.

16. The clutch according to claim 1, wherein the piston is activated hydraulically or pneumatically.

17. The clutch according to claim 1, wherein the slide can be activated against a spring force.

18. The clutch according to claim 3, wherein the number of slides is greater than the number of fluid chambers.

19. The clutch according to claim 1, wherein the fluid is an incompressible fluid.

20. The clutch according to claim 19, wherein the fluid is visco-elastic.

21. The clutch according to claim 1, wherein the fluid is a gel.
